(19) United States
(12) Patent Application Publication
(10) Pub. No.: US 2008/0003070 A1
(43) Pub. Date: Jan. 3, 2008

(54) TOOL ADAPTER

(76) Inventor: Bung-Jzyy Hor, Taichung (TW)

Correspondence Address: PAI PATENT & TRADEMARK LAW FIRM, 1001 FOURTH AVENUE, SUITE 3200, SEATTLE, WA, 98154, US

(21) Appl. No.: 11/428,379

(22) Filed: Jun. 30, 2006

(51) Int. Cl. B23B 45/00

(52) U.S. Cl. 408/124

(57) ABSTRACT

A tool adapter includes a housing, which comprises a passage with two end openings and two locating portions respectively located adjacent the two end openings, two connecting members respectively rotatably positioned in the locating portions of the housing, the connecting members each having a shaft respectively extended out of the end openings and an engagement portion respectively engaged with each other, and two locating devices respectively mounted in the housing to secure the connecting members to the housing.

### BACKGROUND OF THE INVENTION

1. Field of the Invention

The present invention relates generally to a tool adapter for hand tool and, more particularly, to a tool adapter which turns the rotary driving force of a hand tool by 90 degrees to allow the hand tool to work in narrow or angled space, and which is easy to assemble.

2. Description of the Related Art

U.S. Pat. No. 6,463,824 discloses a right angle attachment configured to be attached to a small electrically powered rotary hand tool. The attachment has a flexible input shaft and an output shaft. In operation, the attachment is easily attached to the hand tool by merely removing the chuck that is a part of the original hand tool and attaching the chuck to the attachment output shaft, threadably engaging a driver nut on the rotary tool output shaft, engaging a mounting coupling assembly onto a threaded end of the rotary tool case, and fitting the attachment to the hand tool by merely sliding it into engagement and tightening the coupling assembly by hand.

According to the aforesaid design, the housing that houses the input shaft, the output shaft and other parts of the attachment is comprised of two components. The two components of the housing are abutted against each other. Further, these two components have recessed portions for accommodating the shafts and parts of the attachment. Therefore, this design of right angle attachment has a complicated structure. Further, the assembly process of this design of right angle attachment is also complicated and requires much time. Further, during the operation of the hand tool, cutting chips may be jammed in between the output shaft and the input shaft, causing damage to the parts.

### SUMMARY OF THE INVENTION

The present invention has been accomplished under the circumstances in view. It is one object of the present invention to provide a tool adapter which turns the rotary driving force of a hand tool by 90 degrees to allow the hand tool to work in narrow or angled space. Moreover, the tool adapter has a steady structure that can conveniently and rapidly be assembled.

To achieve this and other objects of the present invention, the tool adapter comprises a housing, two connecting members, and two locating devices. The housing comprises a passage with two end openings and two locating portions respectively located adjacent the two end opening; The two connecting members are respectively positioned in the locating portions of the housing and rotatable relative to the housing, each having a shaft and an engagement portion at one end of the shaft. The engagement portions of the connecting members are engaged with each other. The shafts of the connecting members respectively extend out of the housing through the end openings. The two locating devices are respectively mounted in the housing to secure the connecting members to the housing.

In one embodiment of the present invention, the locating portions of the housing are locating grooves respectively extending from the end openings to the passage and defining a respective shoulder for supporting axle bearings that support the shafts of the connecting members in the housing.

Base on the aforesaid component parts, the tool adapter has a simple and steady structure that is easy and convenient to assemble.

### BRIEF DESCRIPTION OF THE DRAWINGS

FIG. 1 is an exploded perspective view of a tool adapter according to the present invention.

FIG. 2 is an exploded plan view of the tool adapter according to the present invention.

FIG. 3 is a sectional view of the tool adapter according to the present invention.

FIG. 4 is a schematic drawing showing an application example of the present invention.

### DETAILED DESCRIPTION OF THE INVENTION

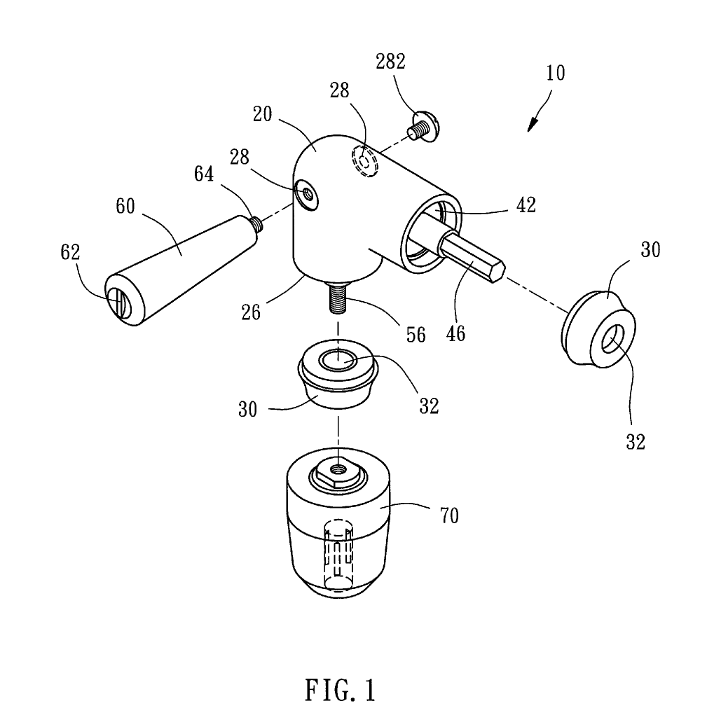

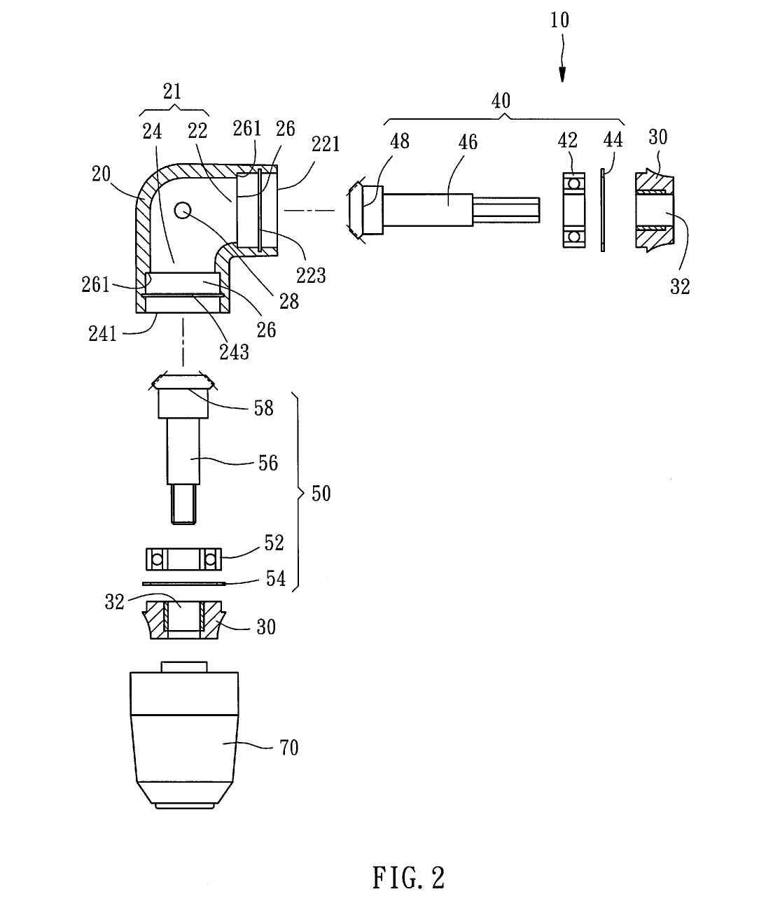

Referring to FIGS. 1 and 2, a tool adapter 10 in accordance with the present invention is shown comprised of a housing 20, two caps 30, a first connecting member 40, a second connecting member 50, a handle 60, and a chuck 70.

The housing 20 is made out of metal in one piece, having a passage 21 with a first end opening 221 and a second end opening 241. The passage 21 having a first section 22 and a second section 24 that are oriented at an approximately 90 degrees relative to each other. The first section 22 and the second section 24 are in communication with each other inside the housing 20. The housing 20 further comprises two locating portions 26 formed on the inside wall and respectively extending from the end openings 221 and 241 along the first section 22 and the second section 24, two shoulders 261 respectively formed on the inside wall adjacent to the locating portions 26, a first positioning groove 223 extending around the inside wall near the first end opening 221, a second positioning groove 243 extending around the inside wall near the second end opening 241, and two screw holes 28 symmetrically disposed at two opposite sides of the housing 20 and in communication with the first section 22 and the second section 24. Through the screw holes 28, lubricating oil is filled into the inside of the housing 20. Further, screws 282 are respectively threaded into the screw holes 28 to prevent applied lubricating oil from flowing out of the housing 20.

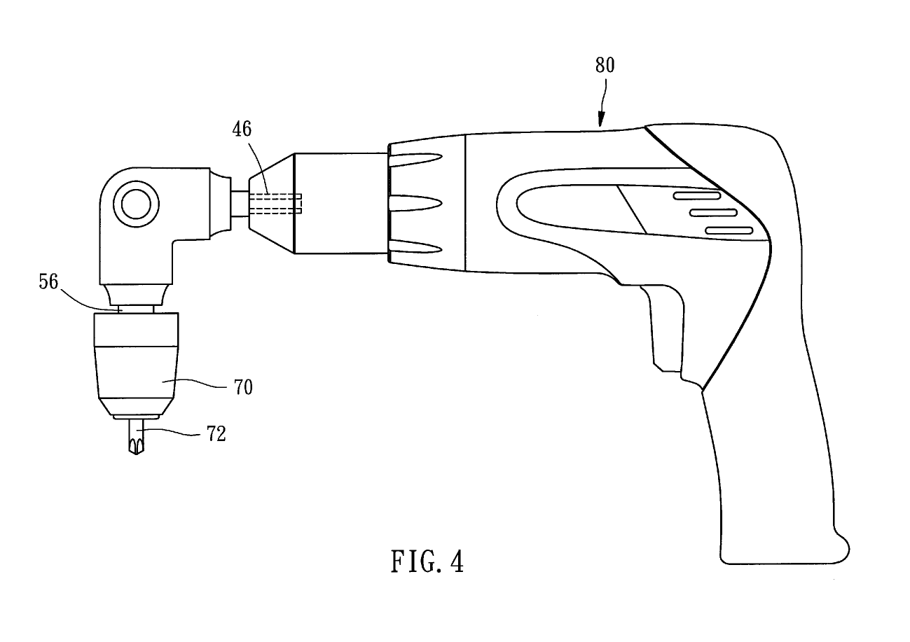

The first connecting member 40 has a shaft 46 and an engagement portion 48 at one end of the shaft 46. The shaft 46 is mounted with a first axle bearing 42. According to this embodiment, the engagement portion 48 is a spiral bevel gear. The first connecting member 40 is inserted through the first end opening 221 into the first section 22 of the passage 21, keeping the first axle bearing 42 positioned in the corresponding locating portion 26 and stopped at the corresponding shoulder 261. Thereafter, a first locating device 44 (for example, C-shaped retaining ring) is fastened to the first positioning groove 223 to secure the first axle bearing 42 and the first connecting member 40 in place, keeping the shaft 46 extended out of the first end opening 221 for the connection of a hand tool 80 (see FIG. 4).

The second connecting member 50 has a shaft 56 and an engagement portion 58 at one end of the shaft 56. The shaft 56 is mounted with a second axle bearing 52. According to this embodiment, the engagement portion 58 is a spiral bevel gear. The second connecting member 50 is inserted through the second end opening 241 into the second section 24 of the passage 21, keeping the second axle bearing 52 positioned in the corresponding locating portion 26 and stopped at the corresponding shoulder 261. Thereafter, a second locating device 54 (for example, C-shaped retaining ring) is fastened to the second positioning groove 243 to secure the second axle bearing 52 and the second connecting member 50 in place, keeping the shaft 56 extended out of the second end opening 241.

The caps 30 each have a center through hole 32. By means of the center through hole 32, the caps 30 are respectively sleeved onto the shafts 46 and 56 of the connecting members 40 and 50 and fastened to the first end openings 221 and the second end opening 241 of the housing 20.

The handle 60 has a coupling block 62 at one end and a screw rod 64 at the other end. By means of the coupling block 62, the handle 60 is used as a screwdriver for rotating the screws 282 out of the screw holes 28. After removal of one screw 282 from the associating screw hole 28, the screw rod 64 of the handle 60 is threaded into the vacant screw hole 28 to be held by the left or right hand when the user is operating the hand tool 80. Further, after connection of the handle 60 to the housing 20, the handle 60 is kept at a right angle to the first section 22 and the second section 24.

The chuck 70 is mounted on the shaft 56 of the second connecting member 50 to hold a tool bit 72 (for example, a tip for screwdriver as shown in FIG. 4).

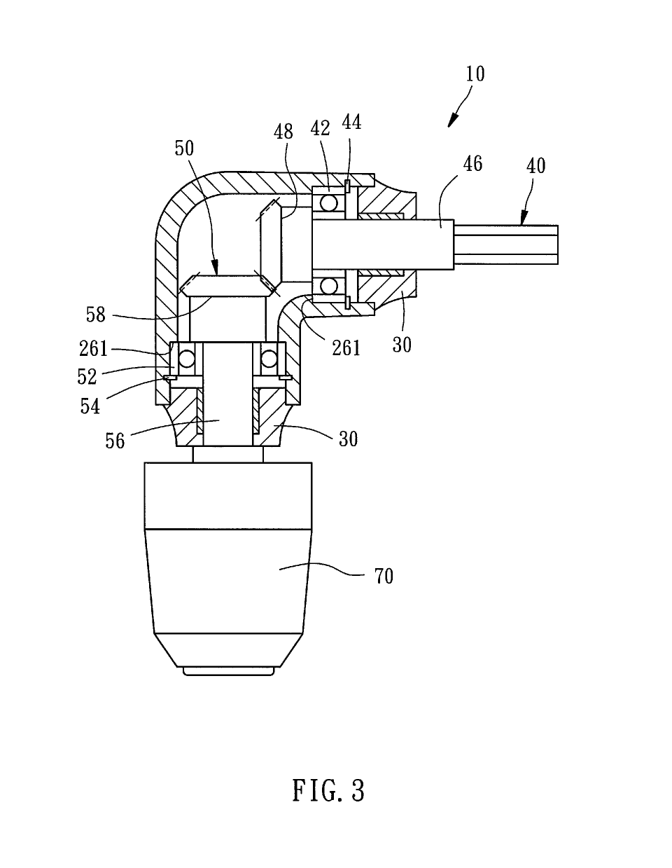

The assembly process of the tool adapter 10 is outlined hereinafter with reference to FIG. 3. The first connecting member 40 and the second connecting member 50 are respectively inserted through the first end opening 221 and the second end opening 241 into the first section 22 and the second section 24 to force the engagement portion 48 and the engagement portion 58 into engagement with each other and at the same time to have the first axle bearing 42 and the second axle bearing 52 be respectively stopped at the respective shoulders 261 and positioned in the respective locating portions 26. Thereafter, the first locating device 44 and the second locating device 54 are respectively fastened to the first positioning groove 223 and the second positioning groove 243 to secure the first and second connecting members 40 and 50 in place, and therefore the tool adapter 10 is assembled. When in use, the handle 60 is fastened to one of the two screw holes 28 as desired, and then the shaft 46 is fastened to the hand tool 80 and the selected tool bit 72 is fastened to the chuck 70 as shown in FIG. 4. Thus, the user can use the hand tool 80 in a narrow working space or angled space area to perform a processing work. Further, because the engagement portions 48 and 58 are spiral bevel gears, the connection between the first connecting member 40 and the second connecting member 50 is steady, and the output rotary driving force of the hand tool 80 can smoothly be transferred to the tool bit 72 through the first and second connecting members 40 and 50.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A tool adapter comprising:
a housing, said housing comprising a passage with two end openings and two locating portions respectively located adjacent the two end opening;
two connecting members respectively positioned in said locating portions of said housing and rotatable relative to said housing, said connecting members each having a shaft and an engagement portion at one end of said shaft, the engagement portions of said connecting members being engaged with each other, the shafts of said connecting members respectively extending out of said housing through said end openings; and
two locating devices respectively mounted in said housing to secure said connecting members to said housing.

2. The tool adapter as claimed in claim 1, further comprising two axle bearings respectively mounted in said locating portions of said housing to support the shafts of said connecting members.

3. The tool adapter as claimed in claim 2, wherein said locating portions of said housing are locating grooves respectively extending from said end openings to said passage and defining a respective shoulder for supporting said axle bearings.

4. The tool adapter as claimed in claim 1, wherein said housing has two positioning grooves for holding said locating devices.

5. The tool adapter as claimed in claim 1, wherein said passage has a first section and a second section, the first section and the second section being connected at right angles, said connecting members respectively inserted through the end openings into the first section and the second section.

6. The tool adapter as claimed in claim 1, wherein the engagement portions of said connecting members are spiral bevel gears.

7. The tool adapter as claimed in claim 1, further comprising two caps respectively capped on said end openings of said housing around the shafts of said connecting members.

8. The tool adapter as claimed in claim 1, further comprising a chuck detachably fastened to the shaft of one of said two connecting members.

9. The tool adapter as claimed in claim 1, further comprising a handle detachably fastened to said housing.

10. The tool adapter as claimed in claim 9, wherein said handle is kept at a right angle to said passage when fastened to said housing.

11. The tool adapter as claimed in claim 9, wherein said handle has a coupling block which allows said handle to be used as a screwdriver for rotating a screw of said housing.
